(19) United States
(12) Patent Application Publication
(10) Pub. No.: US 2017/0351674 A1
(43) Pub. Date: Dec. 7, 2017

(54) PERSONALIZED TASK CONTINUATION ASSISTANT

(71) Applicant: Microsoft Technology Licensing, LLC, Redmond, WA (US)

(72) Inventors: Nishchay Kumar, Hyderabad (IN); Vipindeep Vangala, Hyderabad (IN); Richa Prasad, Seattle, WA (US); Deepinder Gill, Hyderabad (IN); Harris Syed, Redmond, WA (US); Jayaraman Kalyana Sundaram, Redmond, WA (US); Prashant Baktha Kumara Dhas, Bellevue, WA (US)

(73) Assignee: Microsoft Technology Licensing, LLC, Redmond, WA (US)

(21) Appl. No.: 15/170,490

(22) Filed: Jun. 1, 2016

(51) Int. Cl. G06F 17/30

(52) U.S. Cl. CPC G06F 17/3053; G06F 17/30598; G06F 17/30867

(57) ABSTRACT

In non-limiting examples of the present disclosure, systems, methods and devices for assisting with task continuation and completion are provided. First data from a device received from a first context may be received. The first data may be ranked in a clustered intent index, the clustered index comprising a plurality of categorical hierarchies related to the first data. Second data from the device may be received from a second context, the second data providing an indication to assist with task continuation. The relevance of the second data to the clustered first data may be determined, the determining comprising evaluating extracted information from the second data with a threshold related to at least one of the plurality of categorical hierarchies. Content related to the first data may then be sent to the device.

### BACKGROUND

The increasing sophistication of personal assistants on computers has had a large impact on the way users complete simple tasks. However, digital personal assistants are often not as useful for assisting with the completion of long running tasks (i.e., any task that is not completed in one sitting). For example, upon resuming a long running task, a user may have to restart the task or backtrack and perform steps related to task completion that they have previously completed. These issues are compounded when a long running task is carried out on multiple devices at various locations as is often times the case.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Non-limiting examples of the present disclosure describe systems, methods and devices for assisting with task continuation and completion. First data from a device received from a first context may be received. The first data may be ranked in a clustered intent index, the clustered index comprising a plurality of categorical hierarchies related to the first data. Second data from the device may be received from a second context, the second data providing an indication to assist with task continuation. The relevance of the second data to the clustered first data may be determined, the determining comprising evaluating extracted information from the second data with a threshold related to at least one of the plurality of categorical hierarchies. Content relevant to the first data may then be sent to the device.

### BRIEF DESCRIPTION OF THE DRAWINGS

Non-limiting and non-exhaustive examples are described with reference to the following figures:

FIG. 1 is a schematic diagram illustrating an example distributed computing environment for performing personalized task continuation assistance.

FIG. 2 is an exemplary method for assisting with task continuation.

FIG. 3 is an exemplary method for providing enhanced device feedback to assist with task continuation.

FIG. 4 illustrates one example of intent clustering of extracted information from user resources.

FIG. 5 is an exemplary method for assisting with task continuation and providing device feedback when a locational threshold is met.

FIG. 6 is an exemplary method for assisting with task continuation and providing enhanced device feedback when a temporal threshold is met.

FIG. 7 illustrates a computing device for executing one or more aspects of the present disclosure.

FIG. 8 is a simplified block diagram of a computing device with which aspects of the present disclosure may be practiced.

FIG. 9 is a block diagram illustrating physical components (e.g., hardware) of a computing device 900 with which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Generally, the present disclosure is directed to assisting with the continuation of tasks that are to be completed in more than one sitting or browsing session. In particular, content accessed by a device in a first context may be analyzed and data may be extracted from the content for further processing so as to provide enhanced feedback to the device. The extracted data may also be processed for categorization in a plurality of intent clusters. Upon extraction of the content one or more computing devices may evaluate a current device context. Such evaluation may include analyzing metrics such as geolocation of the device, movement of the device, the time of day, day of the week, the month and the year. Upon evaluating the current device context a determination may be made of the relevance of data categorized in intent clusters to the current context. Clusters that are determined to be irrelevant and clusters that are determined to have little relevance, in relation to one or more ranking thresholds, may be filtered. Information and enhanced content related to one or more of the intent clusters that meet one or more ranking thresholds may be sent to the device to assist with task continuation and completion.

According to some aspects a user may begin a task on a device and due to time constraints, insufficient information or other confounding factors, may not be able to complete the task. For example, a user may start a web search for cheap and convenient flights from Los Angeles to Seattle departing the first week of June and returning the second week of June. Before the user is able to locate and purchase a desired flight meeting those criteria the user may be interrupted or otherwise taken off task, only to resume the task at a later time. According to this example the user resources and corresponding content accessed by the user during the initial flight search may be analyzed and data from the content may be extracted for further processing.

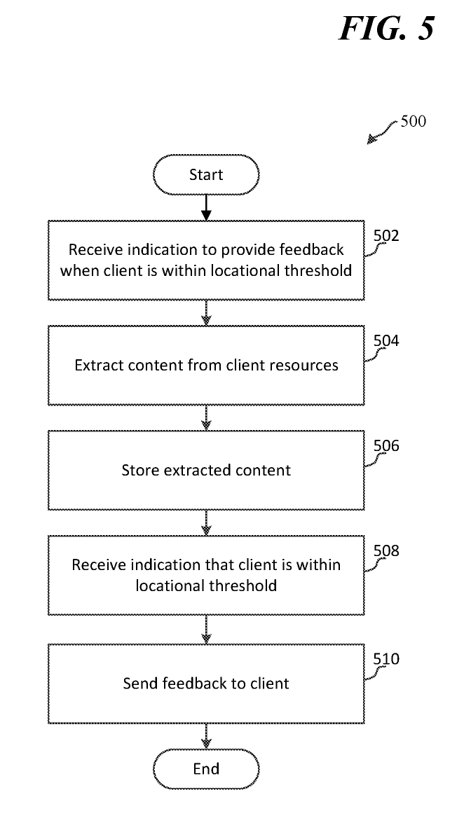

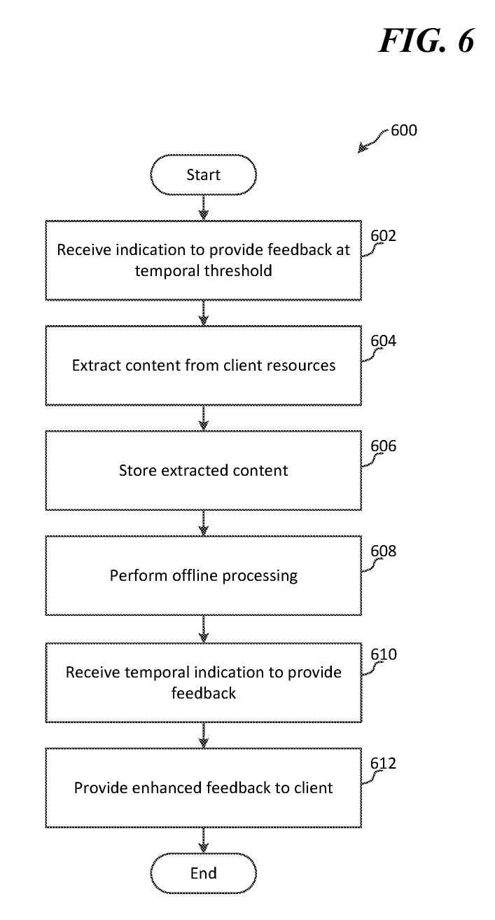

Examples of user resources which may be analyzed include websites browsed, applications accessed, and documents looked at or worked on. For example, in the context of a flight reservation task, the resources analyzed may include airline websites and applications, online travel agency websites and applications, a user's calendar, a user's contact information, applications that track the geolocation of a device, and note taking and reminder applications, amongst others. Alternatively and additionally, a geolocation of a device at the time the user resources were accessed and a time stamp for a time that the user resources were accessed may be attached to or otherwise associated with (e.g., via metadata) the user resources. The geolocation and time stamp may be analyzed as part of the user resource analysis as more fully described in relation to the description of FIG. 5 and FIG. 6 provided below.

According to examples, analysis of user resources may comprise extracting data from the accessed content and categorizing it in a clustered intent index. The clustered intent index may comprise a plurality of categorical hierarchies related to the extracted data. Data extracted may include the text of accessed documents (e.g., a spreadsheet or other word processing document that a user has input compiled flight information and related content into), the content of websites that have been accessed (e.g., time of flights, date of flights, duration of flights, layover locations, duration of layovers, price of flights, etc.), as well as optical character recognition (OCR) of images that have been accessed, by way of example. The extracted data may be further processed prior to categorizing it in a clustered index. According to examples, additional processing of the extracted data may include performing natural language processing, keyword and phrase recognition, pattern recognition, etc.

Analyzing, evaluating and categorizing content from accessed resources and data extracted from accessed resources into a plurality of categorical intent hierarchies may include a multi-tiered categorization process. A determination may be made as to what resources a user has accessed while working on a task. For example, a determination may be made that a user has accessed a web search engine, one or more airline websites and one or more travel booking applications in starting a flight search task. Various metrics may then be used to rank and categorize the user's web browsing and travel application history and rank and categorize the content accessed on those resources in a plurality of categorical intent hierarchies. According to such examples, metrics that may be analyzed in relation to web browsing and application history include: the time spent on a given website or application, how deeply embedded the accessed content is in the website or application, whether the user has searched for related content on other websites or applications, whether the user has bookmarked or otherwise saved an accessed URL to a favorites list, etc.

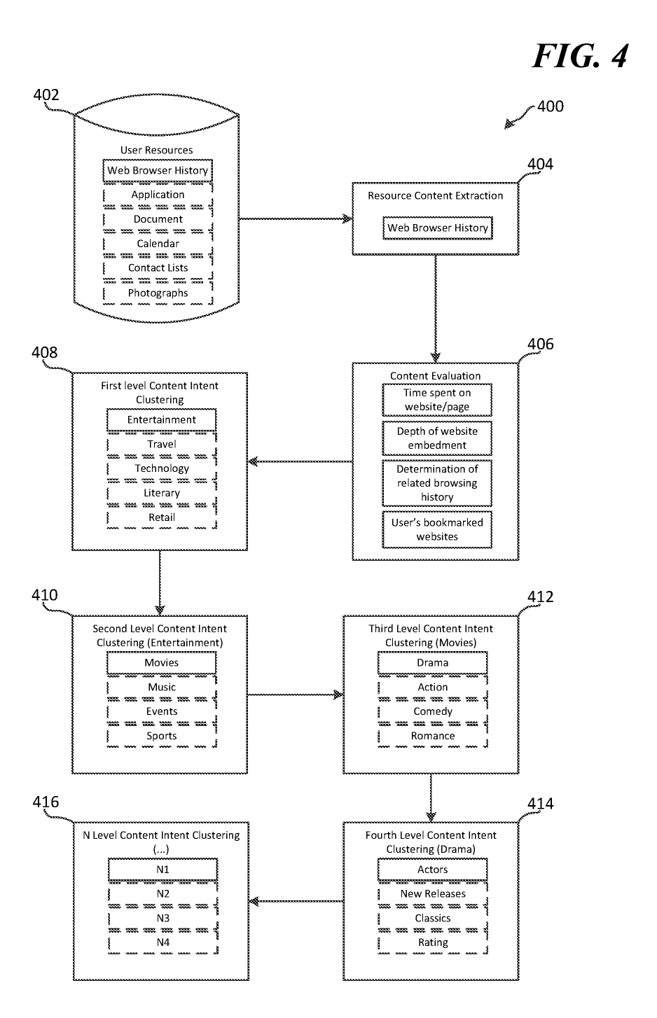

After determining what resources a user has accessed while working on a task and evaluating metrics related to those resources an analysis related to user intent may be made. Such analysis may utilize the data extracted from accessed content and the processing of the accessed content (e.g., natural language processing) to rank and classify the data according to user intent categories (e.g., entertainment, travel, technology, literary, retail, etc.). After performing first level ranking and categorization the data may be further classified into a second tier of the intent hierarchy. For example, if it is determined in the first level ranking and categorization that the highest ranked intent category is travel, a further classification may determine what rank values should be applied to the data in sub-intent categories of travel (e.g., flight, train, car, bus, walking, etc.). Additional intent tiers may be applied according to the first intent tier classification, the analysis of the metrics to determine the rankings in the first intent tier, and the processing of the accessed content as more fully described in relation to the description of FIG. 4 below.

According to certain aspects the data extracted from the user resources may be stored and evaluated in an offline process (e.g., by a server computing device) to provide additional content to a device at a later time. Alternatively and additionally the evaluation of the data extracted from the user resources may be performed in an online manner (e.g., while a user is concurrently performing actions related to a task).

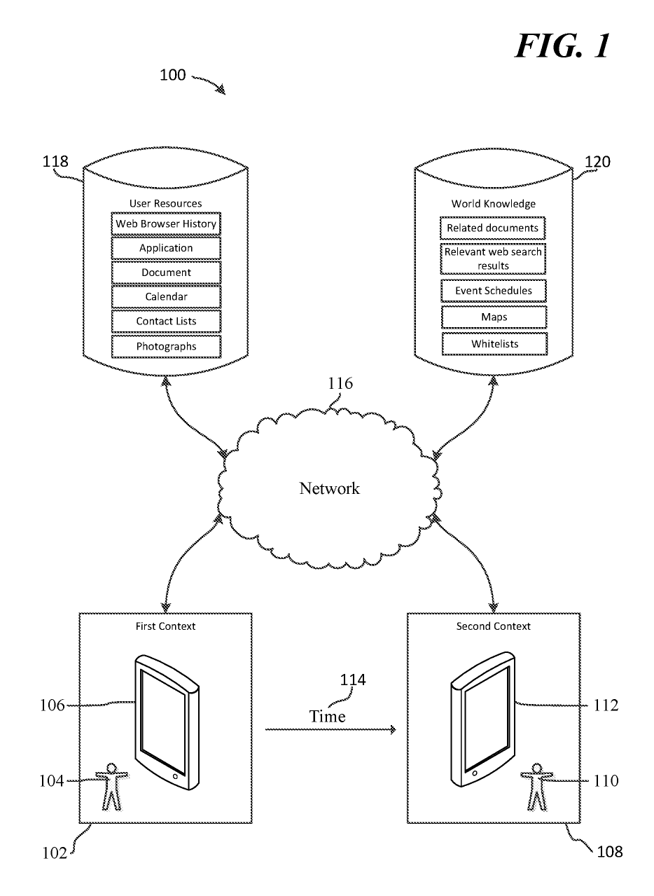

According to the offline and online evaluation techniques described above extracted data may be analyzed and processed to obtain content relevant to a user's task. For example, upon categorizing data related to a first task into at least a first intent categorical hierarchy, a query may be generated to extract content related to the categorized data. Such a query may utilize results from the processing of the extracted data, including: natural language processing results, keyword and phrase recognition results, and pattern recognition results to produce a query string that may be sent to, processed by and query results received from, a web server or one or more of the computing devices as described in relation to FIG. 1.

Further offline and online evaluation techniques may also be applied to the extracted data to obtain content relevant to a user's task. For example, data from web pages that have been browsed, maps that have been looked at, documents that have been read, and applications that have been accessed may be collected at runtime and sent to one or more computing devices for further processing. The further processing may be implemented for specific extracted data that has been categorized in a hierarchical index. Alternatively and additionally, further processing may be implemented for all or a portion of extracted data that has been categorized in a hierarchical index. Such additional processing may be implemented to provide additional content for a suggestion or feedback related to resumption of a task that is not part of the original content accessed by a user.

The further processing of extracted data may include using the results from natural language processing, keyword, phrase and pattern recognition, and OCR of images to compose search strings related to a task. The search strings may be provided to one or more of local and remote search engines. The results obtained from such queries may then be categorized and ranked according to the categorical hierarchies as described herein. According to some aspects the highest ranked results may be proved to a device and the lower ranked results may be filtered out before providing a recommendation or feedback related to an uncompleted task.

According to additional examples queries using the results from natural language processing, keyword and phrase recognition, pattern recognition and OCR may be used to obtain content from resources specific to a user but stored on a remote storage device (e.g., the cloud). Such queries may also be used to obtain content localized to one or more user devices (e.g., via personal computer, laptop, tablet and smart phone memories) to obtain content relevant to a task. For example, local and remote documents, websites and specific web content, application content related to extracted data, user calendars and contact data (e.g., availability, meeting information, persons associated with calendar events), may be analyzed to determine whether content related to a started task should be obtained from those resources. Such a determination may include evaluating whether queries should be generated in relation to those resources, and if content related to those resources and the associated analysis should be provided to a device as feedback for task continuation.

Upon receiving an indication that feedback related to a user's task meets one or more thresholds, content related to the user's task may be sent to one or more user devices. Such thresholds as more fully described below may be evaluated and assessed with relation to time associated data (e.g., is feedback related to a task likely to be useful at, before or during a specific time), date (e.g., is feedback related to a task likely to be useful at, before or on a specific date), location (e.g., is feedback related to a task likely to be useful while a device is at, approaching or moving away from a specific location), contact information (e.g., is feedback related to a task likely to be useful if a user contact is available or unavailable or if the user contact is present at a specific location or meeting), and event context (e.g., is feedback related to a task likely to be useful if the event context meets a time, date, and/or locational threshold).

Turning to FIG. 1, a schematic diagram illustrating an example distributed computing environment 100 for performing personalized task continuation assistance is provided. A user 104 may access a device 106 in a first context 102 and begin working on a task. The first context 102 may relate to a specific time or span of time, a specific geolocation, a direction and speed of movement (e.g., as tracked by device 106), as well as device resources that may be accessed during that context.

User 104 may begin a first task. For example, user 104 may be at home and using device 106 to browse a website of an outdoor gear retail store (e.g., REI.com) to shop for a sleeping bag and other camping gear suitable for a camping trip at the Gorge Amphitheatre in George, Wash. during the month of December. User 104 may access content related to several sleeping bags of interest on the website including reviews for the sleeping bags, video content related to the sleeping bags, and temperature ratings. The user may decide for one reason or another that they would prefer to look at one or more of the viewed sleeping bags in person. As such, the user may decide to stop reviewing content related to camping gear on REI.com, thereby ending the first context 102.

Upon ending the first context 102 a period of time 114 may pass before user 104 has the opportunity to visit a physical location of REI. Once user 104 arrives at or near REI's physical location second context 108 begins. Upon meeting a locational threshold with device 112 in relation to REI's physical location user 110 may access device 112, which may automatically provide feedback to user 110 related to content accessed on device 106 during the first context 102. For example, device 112 may proactively display deep links to user 110's most recently looked at and dwelled upon camping gear on REI.com. Device 106 used to start camping gear search task during context 102 may be the same or a different device than device 112, which provides feedback to user 110 during second context 108. For example, device 106 may be a personal computer used to browse content at home during first context 102. Device 106 may also be a smart phone, laptop or tablet. Device 112, which provides feedback to user 110 during the second context 108 related to content accessed during the first context 102, may be a smart phone or other portable computing device.

User resources 118 comprise content related to a user's computing device, for example device 106 and device 112. For example, the content in user resources 118 may include a user's web browser history, application use history, document viewing and preparation history, calendar entries, contact lists, and photographs. As more fully discussed below in relation to FIG. 4, user resources 118 and associated content may be stored and used to provide feedback to a user in resuming an unfinished task (e.g., shopping for camping gear).

World knowledge 120 comprises information related to content that was accessed by a device and may include documents related to content accessed during a first context, web search results relevant to content accessed during a first context, event schedules relevant to content accessed during a first context, maps and directions relevant to content accessed during a first context, and whitelists relevant to content accessed during a first context. World knowledge 120 may be obtained during offline processing after first context 102 is ended. For example, content accessed during first context 102 may be stored as part of user resources 118. The stored content from first context 102 may be processed during offline processing as more fully discussed below in relation to FIG. 4 to obtain world knowledge 120 which may be provided to device 112 as feedback to user 110 when one or more thresholds related to first context 102 have been met. Alternatively and additionally, world knowledge 120 may be obtained, wholly or partially, during online processing (e.g., while a task is being performed during first context 102).

Device 106 and device 112 may be in communication, via network 116, with one or more computing devices and one or more databases that may contain user resources 118 and world knowledge 120.

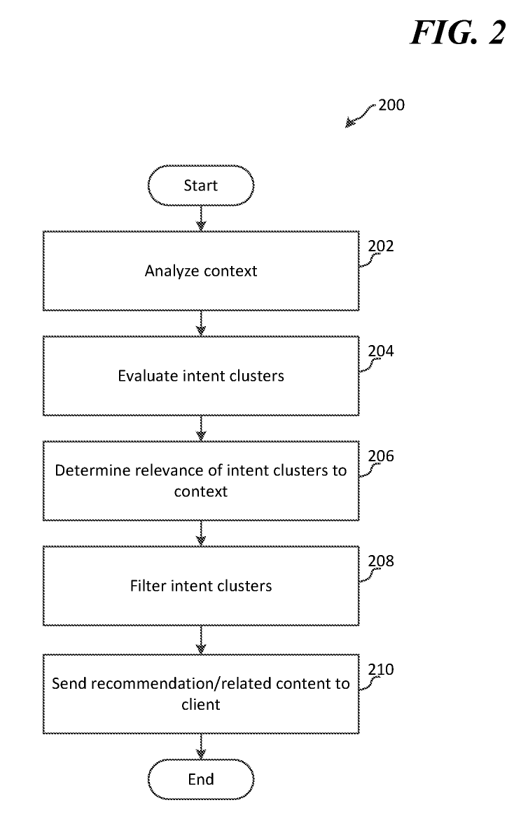

FIG. 2 depicts a flowchart representing a method 200 for providing feedback related to continuing and completing a started task. Flow begins at operation 202 where a context is analyzed. A context may encompass information such as a specific time or span of time, a geolocation of a device, a direction of movement of a device, a speed of movement of a device as well as device resources that may be accessed during that context. At operation 204 one or more intent clusters may be evaluated in relation to the analyzed context and at operation 206 a determination is made as to the relevance of one or more intent clusters to the analyzed context.

Intent clusters, which are more fully discussed below in relation to FIG. 4, provide a mechanism by which extracted data from accessed content (e.g., content a user accesses while performing a task), as well as enhanced feedback content related to the accessed content, may be ranked and classified in a clustered intent index comprising a plurality of categorical hierarchies related to the accessed content. For example, a first tier in a hierarchical clustered intent index may include a plurality of first level intents (e.g., retail, travel, technology, literary, entertainment, etc.) which the extracted data from accessed content and enhanced feedback content related to the accessed content may be ranked. Such ranking may apply a variety of algorithms to the extracted data and the enhanced feedback content in determining the relevance of each of the plurality of first level intents to that information.

After determining the relevance of each of the plurality of first level intents to the extracted data and the enhanced feedback content a plurality of subsequent levels of intents may be invoked. For example, a second tier in the hierarchy falling under the entertainment intent may include second level intents (e.g., movies, music, events, sports, etc.). The extracted data and the enhanced feedback content may then be ranked by relevance to each of the second level intents according to the methods discussed above with regard to ranking of the first level intents. It should be understood that any number of subsequent tiers may be associated with an intent cluster. For example, the entertainment intent cluster may have 1, 2, 3 . . . N tiers of intents that may be applied to the extracted data from accessed content and enhanced feedback content related to the accessed content.

Results from processing extracted data from accessed content may be returned from one or more of natural language processing, keyword and phrase recognition, pattern recognition and OCR. Those results may then be evaluated against the first level intents and value rankings applied to each result and corresponding content. Thus, first accessed content may be determined to be most relevant to the travel intent, and will thereby be associated with the travel intent category or cluster. Alternatively and additionally, first accessed content may be determined to be most relevant to the travel intent, but also relevant to one or more other intents, such as the entertainment intent. In that case, first accessed content will thereby be associated with the travel intent category with a relevance value ranking indicating that the travel intent category is most relevant to the content, and the first accessed content will be associated with the entertainment intent category with a relevance value ranking indicating that the entertainment intent is also relevant to the content, but that its relevance to that intent is secondary to its relevance to the travel intent.

Turning to operation 208 intent clusters and associated ranked content in the hierarchical clustered intent index are filtered. For example, if in analyzing the context at operation 202 it is determined that one or more thresholds has been met for sending feedback to a device related to a started task (e.g., an indication that a device is at or within a radial threshold distance of a location relevant to a started task), one or more intent clusters (e.g., retail, travel, technology, literary, entertainment) and their corresponding tiered intent levels may be filtered such that only the most relevant content, in relation to the particular context, in the clustered intent index will be provided to a device at operation. This feedback is provided at operation 210 where a recommendation and/or related content is sent to a device.

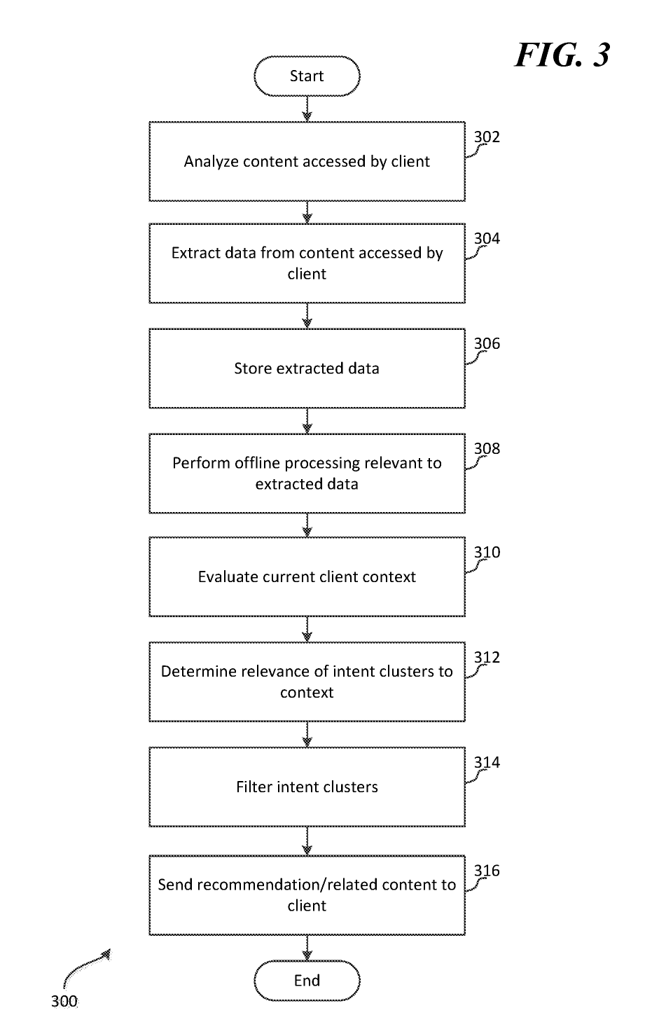

FIG. 3 depicts a flowchart representing a method 300 for providing feedback related to continuing and completing a started task. Method 300 begins at operation 302 where content accessed by a device is analyzed. The content analyzed may be accessed during a first context, for example. Upon analyzing the accessed content flow moves to operation 304 where data accessed by the device is extracted and at operation 306 the extracted data is stored.

Moving to operation 308 offline processing relevant to the extracted data is performed. Offline processing may include analyzing user resources accessed during first context including web browser history, application use history, document creation and review history, as well as user resources that may not have been accessed during a first context, but may be related to a task that has been started in the context. Non-accessed user resources that may be included in offline processing may include calendar information, contact lists and contact-related information (e.g., contact availability) and photographs. Offline processing may also include analyzing world knowledge content. Such content may include documents, web search results and URLs, event schedules, maps and whitelists.

Turning to operation 310 a current device context is evaluated. The current context may be a second context, for example second context 108, in which feedback may be given related to a task that was started during a first context, for example first context 102. The current context may encompass information such as a specific time or span of time, a geolocation of a device, a direction of movement of a device, a speed of movement of a device as well as device resources that may be accessed during that context. Upon evaluating the current device context at 310 flow continues to operation 312 where a determination may be made of the relevance of data grouped in intent clusters to the current context. Clusters that are determined to be irrelevant and clusters that are determined to have little relevance, in relation to one or more ranking thresholds, may be filtered.

At operation 316 information and enhanced content related to one or more of the intent clusters that meet one or more ranking thresholds may be sent to the device to assist with task continuation and completion and the method ends.

FIG. 4 illustrates one example of intent clustering 400 of extracted information from user resources 402. For example, offline and online analysis and processing of user resources may be performed in order to determine the relevance of actions performed on a device in relation to one or more tasks. User resources 402 may include resources such as web browser history, application history, document creation and review history, calendar information, contact lists and contact availability, and photographs.

According to examples, analysis of user resources 404 may comprise resource content extraction 404 from one or more user resources 402. For example, if during a first context a user has begun a task (e.g., looking at camping gear on outdoor retail websites) the web browser history related to that task may be extracted and the content of the web browser history may be evaluated as indicated at 406. Content evaluation of web browser history may include evaluating metrics including time spent on a website, depth of accessed website embedment, determination of related browsing history and whether any of the content viewed during the browsing session has been bookmarked or otherwise saved to a favorites list.

Although web browser history is used as one example of user resources from which content may be extracted, extraction may also include the text of accessed documents (e.g., spreadsheet or other word processing documents that a user has input compiled information and related content into) and OCR of images that have been accessed.

The extracted data from the user resources may be further processed prior to categorizing it in a clustered index. According to examples, additional processing of the extracted data may include performing natural language processing, keyword and phrase recognition, pattern recognition, etc.

Upon performing content extraction of user resources and subjecting the extracted data from those resources to further processing as described above, a first level of content intent clustering may be performed as shown at 408. FIG. 4 provides one example of how web browsing history performed during a first task may be categorized into entertainment intent clusters. However, if one or more intent clusters are determined to be relevant to the extracted data from the user resource it should be understood that categorization into one or more of those intent clusters (e.g., travel, technology, literary, retail, etc.) may also be performed according to the systems and methods described herein.

Performing first level content intent clustering may involve steps including analyzing, evaluating and categorizing content from accessed resources and data extracted from accessed resources into a plurality of categorical intent hierarchies. A determination may be made as to what resources a user has accessed while working on a task. After determining what resources a user has accessed while working on a task and evaluating metrics related to those resources (e.g., time spent on a website, depth of website embedment, determination of related browsing history, user's bookmarked websites, etc.), an analysis related to user intent may be made. Such analysis may utilize the data extracted from accessed content and processing of the accessed content (e.g., natural language processing) to rank and classify the data according to user intent categories.

As shown at 408, first level content intent clustering has been performed and a determination has been made that the most relevant intent cluster to the web browsing history is entertainment, as indicated by the solid rectangle surrounding “entertainment.” One or more of the other first level intent clusters may also be relevant, although to a lesser degree than entertainment, and this lesser relevance is indicated at 408 as the “travel,” “technology,” “literary” and “retail” first level intent clusters are each surrounded by a broken rectangle.

Second level content intent clustering is performed for at least the content in the first level intent cluster that was found to be most relevant to the extracted content. Second level content intent clustering may also be performed for additional content in the first level intent clusters that were found to be relevant to the extracted content, but were not found to be the most relevant to the extracted content. In the example shown in FIG. 4 second level content intent clustering is performed, as shown at 410, on extracted content that was initially clustered in an entertainment cluster. According to this example second level clusters falling under the entertainment first level hierarchy include movies, music, events and sports. Additional analysis may be applied to the data extracted from accessed content to determine a relevance value ranking for each of the clusters within the second level content intent clustering.

As shown at 410, second level content intent clustering has been performed and a determination has been made that the most relevant intent cluster in the second level intent clusters to the web browsing history is movies, as indicated by the solid rectangle surrounding “movies.” One or more of the other second level intent clusters may also be relevant, although to a lesser degree than entertainment, and this lesser relevance is indicated at 410 as the “music,” “events,” and “sports” second level intent clusters are each surrounded by a broken rectangle.

Third level content intent clustering is performed for at least the content in the second level intent cluster that was found to be most relevant to the extracted content. Third level content intent clustering may also be performed for additional content in the second level intent clusters that were found to be relevant to the extracted content, but were not found to be the most relevant to the extracted content. In the example shown in FIG. 4 third level content intent clustering is performed, as shown at 412, on extracted content that was initially clustered in entertainment and movies clusters at first and second levels of the hierarchical content intent clustering, respectively. According to this example third level clusters falling under the entertainment first level hierarchy and the movies second level hierarchy include drama, action, comedy and romance. Additional analysis may be applied to the data extracted from accessed content to determine a relevance ranking for each of the clusters within the third level content intent clustering.

As shown at 412, third level content intent clustering has been performed and a determination has been made that the most relevant intent cluster in the third level intent clusters to the web browsing history is drama, as indicated by the solid rectangle surrounding “drama.” One or more of the other third level intent clusters may also be relevant, although to a lesser degree than drama, and this lesser relevance is indicated at 412 as the “action,” “comedy” and “romance” third level intent clusters are each surrounded by a broken rectangle.

Fourth level content intent clustering is performed for at least the content in the third level intent cluster that was found to be most relevant to the extracted content. Fourth level content intent clustering may also be performed for additional content in the third level intent clusters that were found to be relevant to the extracted content, but were not found to be the most relevant to the extracted content. In the example shown in FIG. 4 fourth level content intent clustering is performed, as shown at 414, on extracted content that was initially clustered in entertainment, movies and drama clusters at first, second and third levels of the hierarchical content intent clustering, respectively. According to this example fourth level clusters falling under the entertainment first level hierarchy, the movies second level hierarchy and the drama third level hierarchy include actors, new releases, classics and rating. Additional analysis may be applied to the data extracted from accessed content to determine a relevance ranking for each of the clusters within the fourth level content intent clustering.

As shown at 414, fourth level content intent clustering has been performed and a determination has been made that the most relevant intent cluster in the fourth level intent clusters to the web browsing history is actors, as indicated by the solid rectangle surrounding “actors.” One or more of the other fourth level intent clusters may also be relevant, although to a lesser degree than actors, and this lesser relevance is indicated at 414 as the “new releases,” “classics” and “rating” fourth level intent clusters are each surrounded by a broken rectangle.

As shown at 416, categorizing extracted content into additional levels of the hierarchical content intent clustering may be performed N number of times. The number of levels of categorization that are performed on a set of extracted content may be dependent on one or more factors. For example, a first number of categorization levels may be performed for the entertainment cluster (e.g., four levels of categorization as shown in FIG. 4), while the same or a different number of categorization levels may be performed for each of the travel, technology, literary and retail clusters, independent of one another.

According to some aspects the number of levels of categorization that are processed for extracted data may vary by user, device, content type, extraction policies, computing costs and resources available. For example, the number of levels of categorization that are processed for extracted data may depend on the type of content that is extracted (web browser history, application history, document, calendar, contact lists, photographs, etc.), the amount of content that is extracted (e.g., 1 megabyte vs. 1 gigabyte), the computing cost of evaluating the extracted content, the amount of time available for offline processing (e.g., the amount of time between a first context, in which a task begins, and a second context, in which a task is resumed), and user account settings, amongst others.

In the case of user account settings, for example, one or more devices associated with a user account may have a settings function that modifies the amount of data that a specific device will use to process intent clustering. That is, a user may wish to limit the data received or sent through a network to one or more server devices that process intent clustering due to network service provider limits, provider plan details and associated costs associated with transmitting and receiving data necessary to process intent clustering.

In addition to categorizing extracted data related to a task and categorizing it into a hierarchical clustered intent index, the systems and methods described herein also provide a user with the ability to personalize the manner in which intent clustering is performed. Specifically, a user may access an application, a personal assistant (e.g., Siri, Cortana, Alexa, Google Now, etc.), account settings associated with one or more devices that perform one or more functions described herein and view all intents associated with one or more tasks (e.g., booking a flight from Seattle to Los Angeles), accessed user resources, and extracted data from those resources, as well as the ranking of that content within the hierarchical clustered intent index.

If upon reviewing that information a user determines that one or more categorizations of content in one or more intents should be moved to a different intent, they may be given the option to assign that content to one or more different intents. Alternatively, if a user determines that categorized content is not helpful in completing a task, they may delete that content from the hierarchical clustered intent index such that it will not be provided as feedback to a user upon resuming that task and that content will not be used to identify related content (e.g., by an automated web search) to be provided as feedback to the user in resuming that task. Additionally, if a user determines that categorized content is ranked inappropriately, they may be given the option to assign that content a different ranking. In this manner, the systems described herein are provided with proactive user feedback which may be used to modify the manner in which categorization of data into the hierarchical clustered intent index is performed. That is, personalized user input described above may be implemented in the systems described herein for machine learning purposes such that content is categorized in a manner unique to a user's preferences (or multiple users for a single account).

The manner in which content is categorized according to user preferences and account settings may be device dependent or device independent. For example, a user may begin a task on a personal computer at home and resume that task on a mobile device while running errands, or vice versa. Thus, each device may have different account settings that affect the manner in which content is categorized and a user's proactive input affecting the machine learning process may vary across devices. Alternatively, a user may determine that each device associated with their account should apply the same settings in categorizing content, and set each device linked to that account accordingly.

The manner in which content is categorized may also be affected by factors including the time of day that elements of the systems and methods described herein are performed (e.g., a user may be more likely to use an unrestricted internet connection during the evening hours and a restricted cellular data connection during afternoon hours), the method in which a device transmits and receives data (e.g., cell phone network vs. internet services provider network), and privacy settings (e.g., a user may not wish to have certain accessed content such as geolocation monitored).

FIG. 5 illustrates an exemplary method 500 for assisting with task continuation and providing device feedback when a locational threshold is met. Flow begins at operation 502 where an indication to provide feedback when a device is within a locational threshold is received. For example, a user may start a grocery list on a device associated with an account that implements aspects of the systems and methods described herein. The grocery list according to this example may be created in an application on that device, such as a notes or reminder application. That list may be generated through tactile input received from a user as well as through voice input (e.g., by accessing the services of a personal assistant). The systems described herein may make an initial determination from this information that user feedback and assistance should be provided in the completion of this task (i.e., grocery shopping) when a device associated with the user's account is within a prescribed locational threshold of one or more locations (e.g., a grocery store). This initial determination may be made based on one or more factors including an initial keyword review of the list and the application used to create the list.

In addition to receiving an indication to provide feedback when a device is within a locational threshold based on automated functions such as keyword detection, a user may proactively indicate that feedback should be provided to them in the completion of a task. According to one example, a user may buy tickets to see a show at the Gorge Amphitheatre on a device associated with their user account. Upon purchasing those tickets and browsing the Gorge Amphitheatre website they may access one or more webpages that have parking instructions and Gorge Amphitheatre rules that they would like to have shown to them when they arrive at the venue. Accordingly, a user may utilize an application or personal assistant on their device and indicate that they would like those webpages, or content found on those webpages, to be sent to a device associated with their account when they arrive at the venue.

As well as receiving an indication to provide feedback when a device is within a locational threshold, an indication may also be received to provide feedback when a device is outside of that threshold, but moving in the direction of that threshold. For example, the method shown in FIG. 5 may also be applied when movement of a device in the direction of a location relevant to task completion is received. A larger locational threshold may be used in this instance. That is, according to examples, a radial threshold of 5 kilometers from a location relevant to task completion may be applied in the case that a device is moving towards that location at a high rate of speed (e.g., by car), and a radial threshold of 1000 meters may be applied in the case that a device is moving towards that location at a slower rate of speed (e.g., by foot).

From operation 502 flow continues to operation 504 where content from accessed device resources is extracted and the extracted content is stored at operation 406. Content may be extracted and stored such that it can be categorized in a hierarchical clustered intent index as described herein, as well as so that related content may be searched for and provided as feedback to a user to aid in resuming a task.

Moving to operation 508 an indication that a device is within a locational threshold is received. As discussed above, such an indication may be received when a device associated with a user's account is within a locational threshold as well as when a device associated with a user's account is within a locational threshold and moving in the direction of a location. From operation 508 flow continues to operation 510 where feedback regarding a started task is sent to a device and the method ends.

FIG. 6 illustrates an exemplary method 600 for assisting with task continuation and providing enhanced device feedback when a temporal threshold is met. Flow begins at operation 602 where an indication to provide feedback when a temporal threshold is met is received. In the example discussed above with regard to providing parking and rules information for the Gorge Amphitheater when a locational threshold is met, a user may be provided with that content, as well as related content derived through offline processing, at a specific time. For example, the systems and methods described herein may make an initial determination that accessed Gorge Amphitheater website content contains a start time and date for the show that a user has purchased tickets to. Upon making this determination an indication to provide feedback at the time of the event or an hour before the event starts, for example, may be made.

As discussed with regard to FIG. 4, a user may also proactively indicate that feedback should be provided to them to aid in the completion of a task. For example, upon purchasing the show tickets and browsing the Gorge Amphitheatre website, a user may access one or more webpages that have parking instructions and Gorge Amphitheatre rules that they would like to have shown to them one hour before the show begins. Accordingly, a user may utilize an application or personal assistant on their device and indicate that they would like those webpages, or content found on those webpages, to be sent to a device associated with their account one hour before the show starts.

Moving to operation 604 content from device resources is extracted and at operation 606 the extracted content is stored. In addition to extracting content that a user has accessed, content related to accessed content may also be extracted. Examples of content related to accessed content that may be extracted include start times for an event stored in a calendar application, availability and geolocation information of one or more contacts in a contact list, etc. For example, in addition to indicating that they would like to be provided with feedback one hour before an event, a user may alternatively or additionally indicate that they would like to be provided with feedback relating to the event when one or more contacts from their contact list are within a locational threshold of the venue where an event is to take place.

From operation 604 flow continues to operation 608 where offline processing is performed. Offline processing may include categorizing content into a hierarchical clustered intent index, as well as obtaining content related to accessed and extracted content. For example, during offline processing of data related to a show at the Gorge Amphitheater, content related to a band that is playing during the show (e.g., a band's website and other tour dates) may be obtained and sent to a user before or at the same time that other requested feedback is provided to a user.

At operation 610 a temporal indication to provide feedback is received. As discussed above, such an indication may be received at the time an event is to begin or an amount of time preceding such an event. From operation 610 flow continues to operation 612 where enhanced feedback regarding a started task is sent to a device and the method ends.

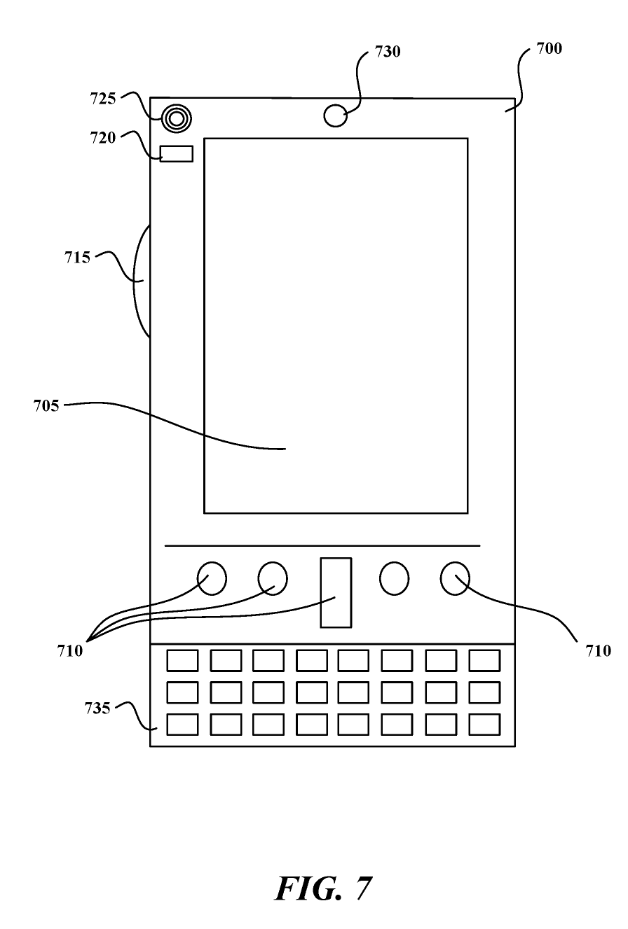

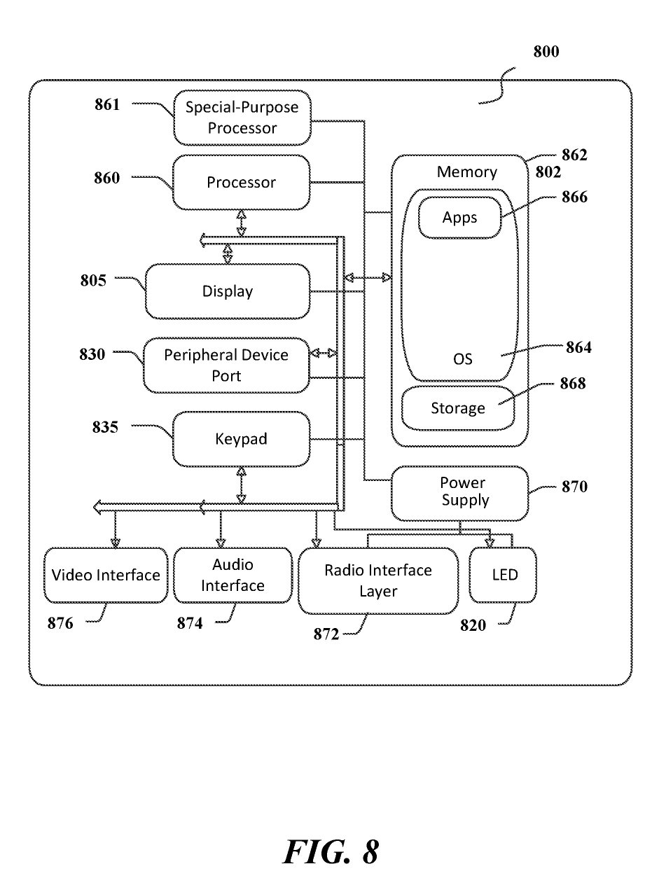

FIG. 7 and FIG. 8 illustrate computing device 700, for example, a mobile telephone, a smart phone, a tablet personal computer, a laptop computer, and the like, with which embodiments of the disclosure may be practiced. With reference to FIG. 7, an exemplary mobile computing device 700 for implementing the embodiments is illustrated. In a basic configuration, the mobile computing device 700 is a handheld computer having both input elements and output elements. The mobile computing device 700 typically includes a display 705 and one or more input buttons 710 that allow the user to enter information into the computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative embodiments, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode) and/or an audio transducer 725 (e.g., a speaker). In some embodiments, the mobile computing device 700 incorporates a vibration transducer for providing the user with tactile feedback. In yet another embodiments, the mobile computing device 700 incorporates input and/or output ports, such as an audio input (e.g., a microphone jack), an audio output (e.g., a headphone jack), and a video output (e.g., a HDMI port) for sending signals to or receiving signals from an external device. In embodiments, the task completion application may be displayed on the display 705.

FIG. 8 is a block diagram illustrating the architecture of one embodiment of a mobile computing device. That is, the mobile computing device 800 can incorporate a system (i.e., an architecture) 802 to implement some aspects of the disclosure. In one aspect the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and a wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, diagramming applications, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored in the host computer. As should be appreciated, other applications may be loaded into the memory 862 and run on the mobile computing device 800, including steps and methods for assisting with task continuation including: receiving first data from a device, the first data received from a first context; ranking the first data in a clustered index, the clustered intent index comprising a plurality of categorical hierarchies related to the first data; receiving second data from the device, the second data received from a second context and providing an indication to assist with task continuation; determining relevance of the second data to the clustered first data, the determining comprising evaluating extracted information from the second data with a threshold related to at least one of the plurality of categorical hierarchies; and sending content relevant to the first data to the device.

The system 802 has a power supply 870, which may be implemented as one or more batteries. The power supply 870 might further include an external power source, such as an AC adapter or a powered docking cradle that supplements or recharges the batteries.

The system 802 may also include a radio 872 that performs the functions of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 866 via the operating system 864, and vice versa. The radio 872 allows the system 802 to communicate with other computing devices such as over a network. The radio 872 is one example of communication media. Communication media may typically be embodied by computer readable instructions, data structures, program modules, or other data in a modulated data signal, such as a carrier wave or other transport mechanism, and includes any information deliver media. The term “modulated data signal” means a signal that has one or more of its characteristics set or changed in such a manner as to encode information in the signal. By way of example, not limitation, communication media includes wired media such as a wired network or direct-wired connection, and wireless media such as acoustic, RF infrared and other wireless media. The term computer readable media is used herein includes both storage media and communication media.

This embodiment of the system 802 provides notifications using the visual indicator 820 that can be used to provide visual notifications and/or an audio interface 874 producing audible notifications via the audio transducer 725. In the illustrated embodiment, the visual indicator 820 is a light emitting diode (LED) and the audio transducer 725 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 725, the audio interface 874 may also be coupled to a microphone to receive audible input, such as to facilitate a telephone conversation. In accordance with embodiments of the present invention, the microphone may also serve as an audio sensor to facilitate control of notifications, as will be described below. The system 802 may further include a video interface 876 that enables an operation of an on-board camera 730 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8 by the non-volatile storage area 868. Computer storage media may include volatile and nonvolatile, removable and non-removable media implemented in any method or technology for storage of information, such as computer readable instructions, data structures, program modules, or other data.

Data/information generated or captured by the mobile computing device 800 and stored via the system 802 may be stored locally on the mobile computing device 800, as described above, or the data may be stored on any number of storage media that may be accessed by the device via the radio 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio 872 or via a distributed computing network. Similarly, such data/information may be readily transferred between computing devices for storage and use according to well-known data/information transfer and storage means, including electronic mail and collaborative data/information sharing systems.

One of skill in the art will appreciate that the scale of systems such as system 802 may vary and may include more or fewer components than those described in FIG. 8. In some examples, interfacing between components of the system 802 may occur remotely, for example where components of system 802 may be spread across one or more devices of a distributed network. In examples, one or more data stores/storages or other memory are associated with system 802. For example, a component of system 802 may have one or more data storages/memories/stores associated therewith. Data associated with a component of system 802 may be stored thereon as well as processing operations/instructions executed by a component of system 802.

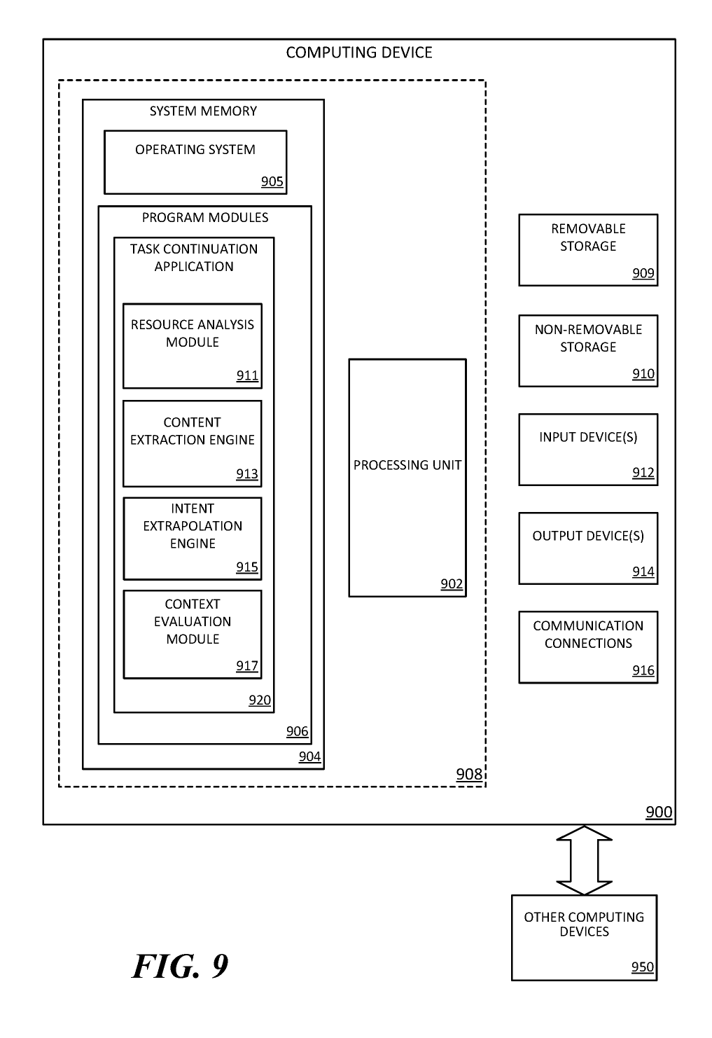

FIG. 9 is a block diagram illustrating physical components (e.g., hardware) of a computing device 900 with which aspects of the disclosure may be practiced. The computing device components described below may have computer executable instructions for assisting with task continuation including: receiving first data from a device, the first data received from a first context; ranking the first data in a clustered index, the clustered intent index comprising a plurality of categorical hierarchies related to the first data; receiving second data from the device, the second data received from a second context and providing an indication to assist with task continuation; determining relevance of the second data to the clustered first data, the determining comprising evaluating extracted information from the second data with a threshold related to at least one of the plurality of categorical hierarchies; and sending content relevant to the first data to the device, including computer executable instructions for task continuation application 920 that can be executed to employ the methods disclosed herein.

In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories. The system memory 904 may include an operating system 905 and one or more program modules 906 suitable for task completion application 920, such as one or more components in regards to FIG. 9 and, in particular, resource analysis module 911, content extraction engine 913, intent extrapolation engine 915, and context evaluation module 917. The operating system 905, for example, may be suitable for controlling the operation of the computing device 900. Furthermore, aspects of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906 (e.g., task continuation application 920) may perform processes including, but not limited to, the aspects, as described herein. Other program modules that may be used in accordance with aspects of the present disclosure, and in particular may include resource analysis module 911, content extraction engine 913, intent extrapolation engine 915 and context evaluation module 917, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

As stated above, a number of program modules and data files may be stored in the system memory 904. While executing on processing unit 902, program modules (e.g., applications, Input/Output (I/O) management, and other utilities) may perform processes including, but not limited to, one or more of the operational stages of the methods described herein.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method for assisting with task continuation, comprising:
receiving first data from a device, the first data received from a first context;
ranking the first data in a clustered intent index, the clustered intent index comprising a plurality of categorical hierarchies related to the first data;
receiving second data from the device, the second data received from a second context and providing an indication to assist with task continuation;
determining relevance of the second data to the clustered first data, the determining comprising evaluating extracted information from the second data with a threshold related to at least one of the plurality of categorical hierarchies; and
sending content relevant to the first data to the device.

2. The method of claim 1, further comprising receiving an indication to provide content relevant to the first data.

3. The method of claim 2, wherein the indication to provide content relevant to the first data comprises an indication to provide content relevant to the first data when a temporal, locational, or contact-related threshold is determined.

4. The method of claim 3, wherein the content relevant to the first data is sent in response to determining that information extracted from the second data meets at least one of a time, a location or a contact-related threshold.

5. The method of claim 2, wherein the indication to provide content relevant to the first data comprises a reactive indication received in response to user input.

6. The method of claim 1, wherein determining the relevance of the second data to the clustered first data further comprises analyzing calendar, locational, and temporal data in metadata sent with the second data.

7. The method of claim 1, wherein ranking the first data in a clustered intent index further comprises analyzing: the device's time spent accessing a resource in the first context; a depth of embedment accessed in the resource during the first context; a search related to the first content; and a review of saved user preferences.

8. The method of claim 1, further comprising analyzing resources related to the device and ranking data from the related resources, the ranking, based at least in part on evaluating the ranked data from the related resources to the categorized first data.

9. The method of claim 8, wherein the analyzed resources comprise at least one of:
a calendar application, a notes application, a web-search engine and a digital personal assistant.

10. A computer-readable storage device-comprising executable instructions that, when executed by a processor, assist with task continuation, the computer-readable medium including instructions executable by the processor for:
receiving first data from a device, the first data received from a first context;
ranking the first data in a clustered intent index, the clustered intent index comprising a plurality of categorical hierarchies related to the first data;
receiving second data from the device, the second data received from a second context and providing an indication to assist with task continuation;
determining relevance of the second data to the clustered first data, the determining comprising evaluating extracted information from the second data with a threshold related to at least one of the plurality of categorical hierarchies; and
sending content relevant to the first data to the device.

11. The computer-readable storage device of claim 10, the instructions further executable by the processor to receive an indication to provide content relevant to the first data.

12. The computer-readable storage device of claim 11, wherein the indication to provide content relevant to the first data comprises an indication to provide content relevant to the first data when a temporal, locational, or contact-related threshold is determined.

13. The computer-readable storage device of claim 12, wherein the content relevant to the first data is sent in response to determining that information extracted from the second data meets at least one of a time, a location or a contact-related threshold.

14. The computer-readable storage device of 10, wherein determining the relevance of the second data to the clustered first data further comprises analyzing calendar, locational, and temporal data in metadata sent with the second data.

15. The computer-readable storage device of claim 10, wherein ranking the first data in a clustered intent index further comprises analyzing: the device's time spent accessing a resource in the first context; a depth of embedment accessed in the resource during the first context; a search related to the first content; and a review of saved user preferences.

16. The computer-readable storage device of claim 10, further comprising analyzing resources related to the device and ranking data from the related resources, the ranking, based at least in part on analyzing its relationship to the categorized first data.

17. The computer-readable storage device of claim 16, wherein the analyzed resources comprise at least one of:
a calendar application, a notes application and a web-search engine.

18. A system for assisting with task continuation, comprising:
a memory for storing executable program code; and
a processor, functionally coupled to the memory, the processor being responsive to computer-executable instructions contained in the program code and operative to:
receive first data from a device, the first data received from a first context;
rank the first data in a clustered intent index, the clustered intent index comprising a plurality of categorical hierarchies related to the first data;
receive second data from the device, the second data received from a second context and providing an indication to assist with task continuation;
determine relevance of the second data to the clustered first data, the determining comprising evaluating extracted information from the second data with a threshold related to at least one of the plurality of categorical hierarchies; and
send content relevant to the first data to the device.

19. The system of claim 18, further comprising receiving an indication to provide content relevant to the first data.

20. The system of claim 19, wherein the indication to provide content relevant to the first data comprises an indication to provide content relevant to the first data when a temporal, locational, or contact-related threshold is determined.
